(19) United States
(12) Patent Application Publication
(10) Pub. No.: US 2024/0053269 A1
(43) Pub. Date: Feb. 15, 2024

(54) METHOD AND DEVICE FOR DETERMINING THE STATE OF CELLS IN REACTORS

(71) Applicant: AQUILA BIOLABS GMBH, Baesweiler (DE)

(72) Inventors: Konrad Herzog, Herzogenrath (DE); David Frank, Herzogenrath (DE)

(21) Appl. No.: 17/766,192

(22) PCT Filed: Oct. 6, 2020
(86) PCT No.: PCT/EP2020/077976

§ 371 Date: Apr. 1, 2022

(30) Foreign Application Priority Data
Oct. 7, 2019 (DE) 10 2019 006 971.4

(51) Int. Cl. G01N 21/64; G01N 21/94

(52) U.S. Cl. CPC G01N 21/6486; G01N 21/6445; G01N 21/94; G01N 2021/6441; G01N 2021/646

(57) ABSTRACT

Methods and devices for evaluating viability and/or degree of contamination of cells cultured in a reactor, which includes providing luminescent dye in the reactor whose luminescence anisotropy is influenced by the viability or the degree of contamination of the cells, exciting the luminescent dye to luminesce by irradiating polarized light into the medium. polarizing light emitted by the luminescent dye that leaves the medium, and detecting the polarized emitted light with a light sensor, where the polarized emitted light is detected as at least two luminescence values in at least two different polarization angles, and determining at least one anisotropy value from the at least two luminescence values by means of mathematical methods, which correlates with the viability or the degree of contamination of the cells.

### CROSS REFERENCE TO RELATED APPLICATIONS

This is a US national phase application under 35 USC § 371 of international patent application no. PCT/EP2020/077976, filed 6 Oct. 2020, which itself claims priority to German application no. 102019006971.4, filed 7 Oct. 2019. Each of the applications referred to in this paragraph are herein incorporated by reference in their entireties.

### TECHNICAL FIELD

The invention relates to a method for determining the state of biological cells in reactors and a device for carrying out the method.

### BACKGROUND OF THE INVENTION

The cultivation of cells in reactors is a fundamental process in many areas of the chemical, biological, biotechnological and pharmaceutical industry and research. In doing so, cells are cultivated in a nutrient medium under defined conditions, wherein the nutrient medium and the cells are in a reactor. To monitor and control such bioprocesses, a wide variety of parameters are collected, such as cell density, oxygen concentration, pH, the temperature, and many more. In order to ensure optimal yield and consistent quality of the bioprocess, further parameters which describe the state of the cultured cells must also be collected frequently, in particular, but not exclusively in the field of mammalian cell culture. In doing so, it is in particular monitored how high the proportion of living cells to the total cell count is (viability) and whether the culture is contaminated or infected with unwanted cells.

While process parameters such as cell density, oxygen concentration, pH or temperature may already be recorded automatically inline or online at the reactor, determining the state of the cells normally requires a laborious and time-consuming drawing of samples with a subsequent manual analysis; which has the disadvantage of low data density and therefore a poorer monitoring quality as well as an increased risk of contamination.

The person skilled in the art knows a wide variety of methods and devices for determining the state of cells that process or otherwise use or analyse samples that were taken from a reactor. Such methods are, for example, microscopic methods for cell counting and classification, staining methods with subsequent evaluation in the microscope or cell counter, enzymatic or immunological assays, genomic or proteomic examinations as well as flow cytometry methods. One disadvantage that is common to all these methods is that they require a sample to be taken from the cell suspension in the reactor, which is laborious and entails a risk of contamination.

Furthermore, methods are known that optimise the above-mentioned methods via a flow-through sample loop or an immersion probe in such a way that sampling is no longer required. Known methods are for example in situ microscopy or at-line flow cytometers. However, since the measuring devices used are relatively large (normally greater than 1000 cm 3), these methods are useful only for corresponding large-volume reactors. The disadvantage here is that for the smaller reactors used very frequently such as shake flasks, shake bottles, microtiter plates, culture tubes or mini and microbioreactors, there is no possibility of determining the state of cells without sampling. This is also very disadvantageous because these smaller reactors can be highly parallelised and are therefore used especially in the field of process development where high data densities are of special importance.

Further, the impedance spectroscopy methods are also known. In doing so, cells are exposed to an alternating electric field of varying frequency by means of electrodes in contact with the culture fluid. Since intact cells can be polarised as a function of size and frequency due to their cell membrane, a distinction can therefore be made between living and dead cells so that only the living cell count is determined. However, it is disadvantageous that these methods require a direct electrical contact between electrodes and culture fluid, such that the former must be designed either as invasive immersion probes or as probes that are integrated into the reactor wall so that the reactors that are normally used can no longer be used. Also, impedance spectroscopy known from the state of the art does not allow any further statements about the state of the cultured cells, for example concerning contamination or metabolism, apart from the living cell count.

Thus, no methods or devices are known which are suitable for determining the state of cells in reactors without direct contact with the culture fluid and without a requirement for sampling and which at the same time can be highly miniaturised and parallelised in order to be used with all common reactors irrespective of size.

### BRIEF SUMMARY OF THE INVENTION

It is therefore the subject matter of the present invention to state a method by means of which at least one state of cells in reactors can be determined without taking samples, without there being a direct contact between the culture fluid and a sensor whilst simultaneously allowing a high degree of parallelisation and miniaturisation of the methods and devices to be used as compared to the state of the art. The subject matter on which the invention is based is achieved by a method for evaluating viability and/or degree of contamination of cells, wherein the cells are cultivated in a medium located in a reactor. An exemplary method includes providing at least one luminescent dye in the reactor whose luminescence anisotropy is influenced by the viability or the degree of contamination of the cells, exciting the at least one luminescent dye to luminesce by irradiating polarized light into the medium that is polarized by at least one light source, polarizing light emitted by at least one luminescent dye that leaves the medium using at least one polarizer, detecting the polarized emitted light with at least one light sensor, wherein the polarized emitted light is detected as at least two luminescence values in at least two different polarization angles, and determining at least one anisotropy value from the at least two luminescence values by means of mathematical methods, which correlates with the viability or the degree of contamination of the cells.

In some embodiments, the emitted polarized light is separated from the exciting light or ambient light by at least one wavelength-selective optical unit and is detected by at least one light sensor for the detection of at least one luminescence value.

In some embodiments, several luminescent dyes are used for the determination of several states. In some embodiments, at least one luminescent dye used is formed by the cells themselves.

In some embodiments scattered light values are also detected at same polarisation angles as the luminescence values and are calculated with the luminescence values by means of mathematical methods to form the at least one scatter-corrected anisotropy value.

In some embodiments temperature of the medium is also detected in order to be able to compensate for temperature dependencies of the luminescence anisotropy of at least one luminescent dye used.

Also disclosed is a device set up to carry out the method for evaluating viability and/or degree of contamination of cells, where the device includes: the at least one light source for irradiating polarized light into the medium that excites the at least one luminescent dye, the at least one light sensor which detects the polarized emitted light, and the at least one polarizer, which is designed such that the emitted light can be polarized in at least two polarisation directions so that the at least one light sensor can detect the polarized emitted light in the at least two polarization angles.

In some embodiments, the at least one light source or the at least one light sensor are each equipped with at least one wavelength-selective optical unit so that the at least one light sensor cannot detect light from the at least one light source.

In some embodiments one respective light sensor is equipped with its own polarizer and a wavelength-selective optical unit as a detector set, and the device comprises at least one detector set for each luminescence value and polarisation angle to be detected.

In some embodiments, at least one polarizer is arranged such that it is in contact with the medium.

### BRIEF DESCRIPTION OF THE DRAWINGS

FIG. 1 is a schematic representation of the method according to the invention.

FIG. 2 is a schematic representation of the interaction of a luminescent dye according to the invention with a cell structure in order to determine the state of a cell.

FIG. 3 is a schematic representation of the interaction of a luminescent dye according to the invention in order to determine the proportion of living cells.

FIG. 4 is a schematic representation of the interaction of a luminescent dye according to the invention in order to determine the proportion of dead cells.

FIG. 5 is a schematic representation of the interaction of a luminescent dye according to the invention in order to determine the proportion of infected cells.

FIG. 6 is a schematic representation of the interaction of a luminescent dye according to the invention in order to determine the proportion of infected and dead cells.

FIG. 7 is a schematic representation of the method according to the invention with scattered light detection.

FIG. 8 is a schematic representation of a device according to the invention with multiple light sources and light sensors.

FIG. 9 is a schematic representation of a device according to the invention with several light sources and light sensors and with polarisers that are in contact with the medium.

### DETAILED DESCRIPTION

### Definitions

To ensure the clarity of some terms used in the description, they will be defined and explained below and in the course of the description.

Cells in the sense of the invention are all biological or chemical systems that are separated (mostly by membranes) that exhibit characteristics of life, i.e. that are characterised in particular, but not exclusively, by the ability to multiply or divide cells and by the ability to carry out metabolic processes and energy exchange. Cells in the sense of the invention are therefore in particular, but not exclusively, all eukaryotes and prokaryotes (bacteria and archaea), artificial or synthetically generated cells, as well as separate systems that have emerged from at least one of the aforementioned cells. Cells possess cell structures at a great variety of levels of molecular or macromolecular organisation. In the sense of the invention, a cell structure is any component of a cell that differs from at least one other component of the cell due to its function, composition, form, structure, localisation, or temporal and spatial presence. Cell structures in the sense of the invention are in particular, but not exclusively, biomolecules (carbohydrates, proteins, peptides, amino acids, lipids, nucleic acids) and their complexes as well as cell organelles and compartments (e.g. mitochondria, nucleus, endoplasmic reticulum, Golgi apparatus, vesicles, lysosomes, vacuoles, endosomes, exosomes, chloroplasts, membranes, cell walls, cytoskeleton, cytoplasm, etc.). However, cell structures in the sense of the invention can also be other physical, chemical or biological structures, in so far as they are located within the outermost extent of the cell, in particular, but not exclusively, phagocytized particles or cell structures, other cells, viruses, phages, mycoplasmas and many more.

All the characteristics of cells define states of cells, the determination of which is part of the subject matter of the present invention. A state of cells in the sense of the invention describes at least one characteristic, the state parameter of at least one cell in at least one point in time, wherein each state parameter must be able to assume at least two different values. Examples of states of cells are in particular, but not exclusively, growth phase, cell cycle phase, vitality or viability, health, freedom from infection, metabolic activity, membrane integrity, size, form, productivity, age, differentiation, proteome, gene activity, etc., wherein each cell exhibits a plurality of states at any point in time. A plurality of the states according to the invention comprises multiple characteristics of the cell. Since the characteristics of the cell and therefore its states are defined by the structure, form, chemical composition, localisation, activity, etc. of the cell components or cell structures, the states defined by them can be inferred via the interaction of luminescent dyes with these cell structures. However, in the sense of the invention, states of cells are not only describable individually for every cell, but also as sums or otherwise mixed states for populations of cells or the totality of all cells in a medium or a reactor. In the field of application of the present invention, the determination of such sum states is frequently of great importance in order to be able to evaluate the quality and integrity of a cultivation of cells. Thus, for example, the viability of a culture describes the proportion of living cells in the total number of all the cells in the medium. According to the invention, sum or mixed states may also be defined for almost every individual state of a cell, which can be described in particular, but not exclusively, by ratios (e.g. viability in percent) or by distributions (e.g. size distribution) with associated distribution parameters (e.g. expected value, variance, skewness, distribution function, etc.).

A medium in the sense of the invention is a mixture of matter that acts as a carrier for the cells when carrying out processes with cells (e.g. cultivation, expression, storage, transport). Media in the sense of the invention are frequently fluids and may contain, among others, nutrients, growth factors, trace elements, luminescent dyes and buffers. Media are frequently mixed in the process to maintain a uniform distribution of their ingredients. Media in the sense of the invention are in particular, but not exclusively, all types of growth, differentiation and expression media for the cultivation of cells and storage fluids.

A reactor in the sense of the invention is any container that may be filled with cells or cell-containing mixtures or media and can be used in particular, but not exclusively, for cultivation, storage, processing, separation or the transport of cells. Reactors in the sense of the invention are, in particular, stirred tank fermenters, bubble column fermenters, shake flasks, T-flasks, microtiter plates, deep well plates, shake barrels, fermentation bags, multipurpose tubes, serum bottles and cell culture dishes. Reactors may be closed or open to their environment. Reactors in the sense of the invention are characterised in that light may be irradiated into them. To this end, reactors according to the invention may have partially or fully transparent walls (with transparency in particular in the wavelength range of the light used to carry out the method according to the invention), wall sections, windows, ports, probes or fibre connectors.

A contaminant in the sense of the invention is a substance, structure, cell, or particle (e.g., viruses, phages, mycoplasmas, other bacteria, prions) which affects the behaviour or various states of a cell in such a way that the cell behaves differently, and usually differently in an undesirable way, in the presence of the contaminant than in the absence of the contaminant.

Luminescent dyes in the sense of the invention are all substances, ions, molecules, macromolecules or complexes thereof which exhibit luminescence, i.e. which, depending on their electron structure, may be brought to an excited state by at least one photon and leave this excited state again with the emission of at least one photon after a certain lifetime. Luminescent dyes in the sense of the invention are, in particular, fluorescent dyes and phosphorescent dyes. The luminescence of luminescent dyes is dependent on their environment and may be altered by interaction of the luminescent dye with the environment, in particular, but not exclusively, in respect of the excitation and emission spectra, the lifetime of the excited state, and the polarisation or polarisation rotation of the emitted light. Luminescent dyes according to the invention exhibit luminescence anisotropy depending on the luminescence lifetime and the interaction with their environment which in particular, but not exclusively, describes how strongly the emitted light is depolarised after excitation of a luminescent dye with polarised light. The higher the depolarisation of the emitted light, the lower the luminescence anisotropy; and the higher the polarisation of the emitted light, the higher the luminescence anisotropy. Luminescence is detected by appropriate light sensors. In the sense of the invention, luminescence values may be recorded in particular, but not exclusively, using static intensity measurements or by means of time-resolved methods in the frequency or time domain. The methods and modulation techniques required for this are known to the person skilled in the art.

A light source is any device which is suitable for emitting light into the reactor and/or the medium. Light sources in the sense of the invention include in particular, but not exclusively, LEDs, OLEDs, lasers, incandescent lamps, fluorescent tubes, flash tubes, and combinations of these light sources with at least one fluorescent layer. Light sources in the sense of the invention may contain a variable or fixed polariser to produce polarised light, may be combined with an external variable or fixed polariser or may produce polarised light themselves. Light sources in the sense of the invention may cover only one wavelength or a narrow wavelength range (laser, LED, OLED) or have a broad wavelength range. Since a narrow wavelength range is frequently advantageous for luminescence detection, light sources may contain wavelength-selective optical elements such as bandpass or edge filters, other filters, monochromators, prisms or diffraction gratings or may be combined with such optical elements. Light sources have a field of view that corresponds to the illuminated volume in general, but in particular to the illuminated volume of the medium in the reactor. Light sources may be combined with various optical elements in order to modify the field of view in the medium.

The wavelength of light in the sense of the invention describes both defined wavelength lines and wavelength ranges with at least one, but usually two limits. Examples of the use of the term wavelengths in the sense of the invention are “a laser with a wavelength of 532 nm” or “an excitation wavelength smaller than the emission wavelength”; wherein the latter may also correspond to several wavelength ranges. The wavelength is abbreviated in the figures with the Greek letter lambda.

A polariser in the sense of the invention is any device capable of polarising light or of transmitting or reflecting only a certain part of the light with certain characteristics with respect to polarisation. Polarisers in the sense of the invention may be single polarising elements or arrangements of several polarising elements with the same or with different polarisation directions.

The polarisation angle in the sense of the invention is the angle between the polarisation of the polarised exciting light and the polarisation of the polarised emitted light or polarised scattered light.

A light sensor in the sense of the invention is any device that is suitable for detecting light by at least one characteristic of the detected light (in particular intensity) causing an electrical reaction of the sensor (e.g. a change in an electrical voltage, an electrical potential, an electrical current) that can be detected, read, further processed, converted or stored by further electronic components (e.g. analogue-to-digital converters, operational amplifiers, comparators, resistors, capacitors, processors, computers, etc.), which may be part of the light sensor or connected downstream thereof, and ultimately captures the detected characteristic of the light as at least one value. A light sensor therefore captures a direct or processed or modified image of the electrical response of the sensor at a particular time. Light sensors in the sense of the invention are in particular, but not exclusively, photodiodes, photoresistors and phototransistors present individually or as an array or another combination of individual sensors, as well as 1D CCD chips (line sensor), 2D CCD chips, 1D CMOS APS chips (line sensor), 2D CMOS chips, photomultiplier tubes, silicon photomultipliers, avalanche photodiodes, as well as light sensors with fluorescent coating (e.g. for UV detection). The above-mentioned electronic components of light sensors may be partially shared between several sensors, for example via suitable multiplexers. Light sensors may contain polarisers or wavelength selective optics or be combined with them. Similar to light sources, light sensors also have a field of view and may be combined with different optical elements in order to modify the field of view in the medium or the reactor.

Wavelength-selective optics in the sense of the invention are all optical elements that prefer, prevent or redirect the propagation, in particular the transmission, reflection and diffraction, of light of a specific wavelength. Wavelength selective optics in the sense of the invention are in particular, but not exclusively, filters (edge, notch, bandpass, short-pass, long-pass filters), prisms, optical gratings and slits, and monochromators.

Mathematical methods in the sense of the invention are all methods that are suitable for analysing, processing, combining into new values, or drawing conclusions from data and measured values that have been acquired or calculated or derived by means of the method according to the invention. Mathematical methods in the sense of the invention are in particular, but not exclusively, methods of statistics, regression analysis, optimisation and compensatory calculus, machine learning and evolutionary algorithms and neural networks.

An anisotropy value in the sense of the invention is any value or combination or series of values which describes the luminescence anisotropy of at least one luminescent dye at a particular point in time or over a given period.

A computer in the sense of the invention is any device capable of storing data (especially arithmetic and logic) and processing them based on programmable rules. Computers in the sense of the invention are in particular, but not exclusively, microcontrollers, microprocessors, FPGAs, system-on-a-chip (SoC) computers, PCs, and servers.

### Solution

According to the invention, the subject matter is obtained by a method for determining the state of cells in reactors, which uses the effect of luminescence anisotropy, to be implemented as an optical method without direct contact with the culture fluid and with a high minimisation and parallelisation potential.

The subject matter is obtained by a method for determining the state of cells that are cultivated in a medium which is located in a reactor, wherein at least one luminescent dye is located in the reactor, the luminescence anisotropy of which is dependent on its ambient conditions and wherein at least one ambient condition of the luminescent dye is influenced by at least one state of the cells. Thus, the subject matter according to the invention is based on the optical detection of the luminescence anisotropy of at least one luminescent dye as a measure of at least one state of the cells.

The method according to the invention is characterised in that light polarised by at least one light source is irradiated into the medium and excites the at least one luminescent dye to luminescence, and that the light emitted by at least one luminescent dye at least partially leaves the medium and is polarised by at least one polariser.

It is further characterised in that the polarised emitted light thus obtained is detected by at least one light sensor and that the polarised emitted light is detected as at least two luminescence values in at least two different polarisation angles, from which at least one anisotropy value is determined by means of appropriate mathematical methods, which correlates with at least one state of the cells as a result of the environmental dependence of the luminescent dye.

The method according to the invention uses the dependence of the luminescence anisotropy of at least one luminescent dye on its environmental conditions. In doing so, the luminescence anisotropy changes by a great variety of physical processes, in particular, but not exclusively, by diffusion and rotation of the luminescent dye, by various types of radiation-free energy transfer (RET, FRET, etc.) or by radiative transfer, and by other parameters (e.g. pH, shape, stability and size of the hydrate shell, viscosity of the solvent, temperature, pressure) and processes affecting the electron structure or the molecular mobility and rotation rate of the luminescent dye.

Luminescent dyes according to the invention for determining at least one state of cells are characterised in that their luminescence anisotropy may be influenced by at least one state of the cells. In this respect, the environmental conditions of luminescent dyes according to the invention must have the capability to change depending on at least one state of the cells. This is achieved in particular, but not exclusively, by the cell state-dependent interaction of luminescent dyes according to the invention with at least one cell structure, such as cell compartments or cell components (proteins, polysaccharides, lipids, nucleic acids, etc., as well as their compounds, complexes or derived structures). However, this is also achieved by the cell state-dependent interaction of luminescent dyes according to the invention with at least one structure that is not part of the cell in the true sense, but is located within the cell or medium and in this way influences the state of the cells. Such structures, which are not part of the cell in the actual sense, are in particular, but not exclusively, contaminants, bacteria, viruses, phages, prions, mycoplasmas, etc.

According to the invention, the interaction of the at least one cell structure with the at least one luminescent dye depends on at least one characteristic of this cell structure, in particular, but not exclusively, on the presence, concentration, conformation, charge, size and localisation of the cell structure, and on its accessibility by the luminescent dye. According to the invention, differences relating to at least one characteristic of the cell structure interacting with at least one luminescent dye arise depending on the state of the cells, so that the interaction of at least one luminescent dye with at least one cell structure and, from this, the cell state influencing the at least one interaction characteristic of the cell structure with the luminescent dye may be concluded from the determined luminescence anisotropy.

In some embodiments of the invention, the cell state-dependent change in luminescence anisotropy of at least one luminescent dye takes place through its binding to at least one cell structure or through its dissociation from at least one cell structure. According to the invention, in these embodiments, depending on the binding state of the luminescent dye, its mobility changes, in particular, but not exclusively, its diffusion or rotation rate, and therefore its luminescence anisotropy.

In some embodiments of the invention, the cell state-dependent change in luminescence anisotropy of at least one luminescent dye takes place through its localisation in or on at least one cell structure, wherein the localisation (e.g., lysosome, vacuole, mitochondria, cell wall, nucleus, etc.) is associated with different environmental conditions, especially, but not exclusively, with regard to pH, redox potential, charge, polarity, viscosity, ionic strength, or solvent composition. According to the invention, in these embodiments, depending on the local environmental conditions of the luminescent dye, its mobility or the electron structure, and therefore its luminescence anisotropy, changes.

In some embodiments of the invention, the cell state-dependent change in luminescence anisotropy of at least one luminescent dye is achieved by energy transfer to suitable adjacent cell structures as acceptor molecules. This energy transfer may take place radiation-free (RET/FRET) or under the emission of radiation. In particular, since radiation-free energy transfer depends on the distance between the donor and acceptor, in such embodiments states of cells whose change is associated with a change in distance on at least one cell structure or between two cell structures or disintegration of cell structures may be determined. According to the invention, in these embodiments, depending on the efficiency of the energy transfer or the lifetime of the excited states of donor or acceptor, the luminescence anisotropy changes, and both the luminescence anisotropy of the donor and of the acceptor may change.

In some embodiments of the invention, irrespective of the nature of the interaction of at least one luminescent dye with at least one cell structure, determination of the state of the cells is made by the accessibility of the cell structure required for the interaction. In an advantageous embodiment of the invention, this may be used in particular to determine the integrity of the cell membranes or cell walls and to determine the state of transport proteins, channels and endocytosis or exocytosis processes.

Luminescent dyes according to the invention may be intrinsic molecules of cells which are formed, consumed or secreted by them (e.g. NADH, NADPH, flavins, aromatic amino acids and their derivatives, porphyrins, pigments, fluorescent proteins, etc.). Luminescent dyes according to the invention may also be externally added molecules (e.g. neutral red, methylene blue, toluidine blue, DAPI, trypan blue, etc.). These may be part of the medium or added as required.

In an advantageous embodiment of the invention, the luminescence anisotropy of a luminescent dye is affected by just one state of the cells so that the state of the cells may be quantified directly via the quantification of the luminescence anisotropy.

To be able to detect significant differences in the luminescence anisotropy of an interacting and a non-interacting luminescent dye, depending on the resolution and sensitivity of the device according to the invention, in some embodiments of the invention, the luminescence lifetime or time constant will be less than the correlation time or correlation constant of the interacting luminescent dye and greater than the correlation time or correlation constant of the non-interacting luminescent dye. In other embodiments of the invention, for the same purpose, the correlation time or correlation constant of the interacting luminescent dye will be up to 10-fold, up to 100-fold, up to 1000-fold, or more than 1000-fold greater than the correlation time or the correlation constant of the non-interacting luminescent dye.

In an advantageous embodiment of the invention, the determination of the luminescence anisotropy as a ratiometric anisotropy value is performed by detecting the polarised emitted radiation for several, but at least two, different polarisation angles. Advantageously, by using ratiometric anisotropy values, adverse phenomena such as photobleaching, metabolisation, new formation or decay of luminescent dyes may be avoided.

According to the invention, the calculation of at least one anisotropy value from at least two luminescence values takes place by means of suitable mathematical methods on at least one computer.

In some embodiments of the invention, to set at least two different polarisation angles, the polarisation of the exciting light is kept constant and the emitted light is polarised by at least one polariser between the medium and at least one light sensor, wherein the different polarisation angles are set by the at least one polariser or otherwise by multiple polarisers in combination with one or more light sensors. In some other embodiments of the invention, in order to set at least two different polarisation angles, detection of the light is carried out by at least one light sensor under constant polarisation while the polarisation of the exciting light is changed, for example by at least one variable polariser in front of at least one light source or by several light sources with fixed integrated or external polarisers of a different arrangement or by light sources emitting polarised light with polarisation rotating optics (for example by retardation plates such as 212 plates).

In some embodiments of the invention, multiple, but at least two, luminescent dyes are used to determine different states of cells simultaneously or sequentially (e.g., viability, metabolic activity, growth phase, contamination, etc.). According to the invention, the determination of the anisotropy values is then carried out advantageously at different excitation or emission wavelengths.

In some embodiments of the invention, multiple, but at least two, luminescent dyes are used which are used for the complementary determination of the same condition (e.g., determination of viability by determination of the living cells with one luminescent dye and of the dead cells with another). According to the invention, the determination of the anisotropy values is then carried out advantageously at different excitation or emission wavelengths.

In an advantageous embodiment of the invention, during the detection of at least one luminescence value, no light source emits light into the medium which has the same wavelength as the light emitted by at least one luminescent dye. In some embodiments of the invention, this is achieved by using light sources with appropriate wavelength characteristics (laser, LED). In other embodiments, this is achieved by combining at least one light source with at least one wavelength-selective optic, which advantageously only emits light of the wavelength required for excitation of the luminescent dye into the medium.

In an advantageous embodiment of the invention, there is at least one wavelength-selective optical unit in the beam path between the medium and at least one light sensor, which ensures that only light with the correct wavelength is detected by the light sensor assigned to it. Consequently, in an advantageous embodiment of the invention, light sensors for detecting light emitted from luminescence processes in particular are set up and provided with a wavelength-selective optical unit in such a way that they detect exclusively or at least predominantly the emitted light and no other light, for example excitation light or ambient light. The same applies to sensors for scattered light detection of exciting light and emitted light.

In some embodiments of the invention, a particular portion of at least one luminescent dye is fixed in a defined state, and thus with invariant luminescence anisotropy, by suitable methods to act as a reference variable to which changes in luminescence anisotropy can be referenced. In some embodiments of the invention, such references are located in patches within the reactor in a fixed manner (e.g., by embedding them in a gel or plastic) and are evaluated by a dedicated reference channel consisting of a light source, polariser, and light sensor.

In some embodiments of the invention, the method according to the invention comprises the use of monochromators, filters, gratings, or other wavelength-selective optical units in order to separate the excitation light and the emission light for each luminescent dye.

In an advantageous embodiment of the invention, the polarisers produce linearly polarised light.

In an advantageous embodiment of the invention, all optical components as well as sensors, light sources and computers are situated outside the reactor. In other embodiments, however, they may be located within the reactor, with suitable sheathing and optical windows if required, or they may be immersed in the medium as immersion probes.

In some embodiments of the invention, scattering of both the polarised exciting light and the emitted light may affect or distort the determination of the anisotropy value. To counteract this and to correct scattered light artifacts using appropriate mathematical methods, in some embodiments the method according to the invention comprises recording scattered light values, in particular at the same polarisation angles as used for recording the luminescence values, and in particular at the excitation and emission wavelengths that are used for the relevant luminescent dye.

In some embodiments of the invention, at least one light source, and at least one light sensor, are arranged in such a way that the volume containing cells in the common field of view of the at least one light sensor and the at least one light source is so small that the scattering of light within this field of view is extremely unlikely and thus the influence of light scattering on the determined anisotropy values is minimised or eliminated. According to the invention, this volume in the common field of view of at least one light sensor and at least one light source must decrease with increasing cell density in order to prevent scattering from the cells or cell structures efficiently. In some embodiments of the invention, the common field of view of at least one light sensor and at least one light source is therefore variably adjustable by suitable optical or optomechanical devices. Therefore, in some other embodiments of the invention, the common field of view of at least one light sensor and at least one light source is designed to have no or only little scattering effects acceptable for anisotropy detection up to a known maximum cell density in the medium. In some other embodiments of the invention, scattering effects as a function of cell density may be prevented by combining different light sources and light sensors into at least one light source/light sensor pair. In doing so, various light sources and light sensors are arranged in such a way that a combination of at least one light source and at least one light sensor results in common fields of view of different sizes so that an optimum between minimum stray light and maximum luminescence intensity may be achieved advantageously. In an advantageous embodiment of the invention, cell density is also detected to be able to assess the influence of scattering effects and, depending on this, to generate optimum light source/light sensor combinations. A wide variety of methods and devices are known to a person skilled in the art for determining cell density. In some embodiments of the invention, luminescence values of the same luminescent dye are detected in parallel by multiple light source-light sensor pairs with different fields of view in order to then detect the influence of light scattering by means of suitable mathematical methods and minimise or eliminate it in the calculation of the anisotropy value.

In some embodiments of the invention, the exciting light or emitted light is directed or otherwise affected by fibre optic components, light guides, or other optical elements such as lenses, apertures, slits, prisms, or mirrors, in particular, but not exclusively, to achieve optimal field of view geometries, field of view positions or field of view arrangements for light sensors or light sources.

In some embodiments of the invention, some or all components of the device according to the invention that are in the path of the exciting or emitted light are coated or otherwise adapted, fabricated, or created in such a way that no light scattering or only extremely low light scattering occurs in or on them and in the matter surrounding them in the range of the wavelengths used.

In some embodiments of the invention, the polarisers of the device according to the invention are in contact with the medium so that, apart from scattering effects within the medium and the cells, no other scattering effects will affect the detection of the luminescence values or the scattered light values. In some embodiments of the invention, the polarisers of the device according to the invention are integrated into the wall of the reactor for this purpose.

According to the invention, the detection of the emitted light under several, but at least two different polarisation angles may take place both in parallel and sequentially. In an advantageous embodiment of the invention, embodiments for the parallel detection of the emitted light in at least two different polarisation angles comprise at least one polariser with associated light sensor for every polarisation angle to be detected. Such methods can be implemented advantageously in devices according to the invention without the use of moving components, which is especially desirable in harsh industrial, shaken or vibrating applications. Embodiments for the sequential detection of the emitted light in at least two different polarisation angles comprise at least one variable polariser and at least one light sensor.

In some embodiments of the invention, the detection of the emitted light may be performed at multiple excitation and/or emission wavelengths. This may be done both in parallel and also sequentially. In an advantageous embodiment of the invention, embodiments for the parallel detection of the emitted light in at least two different polarisation angles comprise at least one polariser with an associated light sensor for every polarisation angle to be detected. Such methods can be implemented advantageously in devices according to the invention without the use of moving components, which is especially desirable in harsh industrial, shaken or vibrating applications. Embodiments for the sequential detection of the emitted light in at least two different polarisation angles comprise at least one variable polariser and at least one light sensor.

In some embodiments of the invention, multiple anisotropy values are detected for a luminescent dye at different excitation and/or emission wavelengths. In particular, but not exclusively, this may be used to improve the resolution of cell states, to increase robustness of state determination and to determine multiple states over the same luminescent dye.

In some embodiments of the invention, especially in methods with continuous shaking, the luminescence values are advantageously detected at a frequency which is greater than the shaking frequency to compensate for the influence of different fluid distributions of the medium in the reactor. A wide variety of methods and devices are known to the person skilled in the art for compensating and adapting optical measurements to dynamic fluid systems.

In an advantageous embodiment of the invention for dynamic fluid systems, in particular, but not exclusively, for continuously mixed reactors, all luminescence values, or all luminescence values and scattered light values, are detected in parallel at the respective polarisation angles provided according to the invention. This facilitates, especially for the determination of ratiometric anisotropy values, the use of longer integration times which also allow the detection of low-concentration luminescent dyes. Provided that all luminescence measurements are performed ratiometrically in parallel, the ratio of the individual luminescence values will not change even if, for example, the absolute luminescence values change permanently on account of periodic fluctuations in the liquid level during a shaking operation.

In some embodiments of the invention, pulsed or otherwise modulated light sources are used for the purpose of ambient light compensation so that the influence of ambient light on the determined anisotropy values may be minimised or eliminated by suitable signal processing of the luminescence and scattered light values.

In some embodiments of the invention, the temperature of the medium is detected for each measurement to be able to correct influences of the temperature, in particular on the rotation and diffusion rate of the luminescent dyes according to the invention, using appropriate mathematical methods.

According to the invention, individual anisotropy values are combined into time series which give information about the state to be determined or the states to be determined over the entire course of a cultivation or other processing of cells and allow the user of the method according to the invention to draw conclusions about the biological events during cultivation and subsequent process optimisation.

### PREFERRED EMBODIMENTS WITH REFERENCE TO THE DRAWINGS

The present invention is explained in greater detail with reference to the figures and example embodiments. Reference numerals in the figures that designate components of the invention that have already been used in the same figure or in another figure under the same circumstances or the same representation, are omitted in some cases in order to maintain the clarity and transparency of the figures. Graphic elements without reference numerals are therefore to be interpreted under consideration of the list of reference numerals, the other figures, the designated representations within the same figure, the patterning or structuring of graphic elements already designated and also with reference to the entire description and the claims.

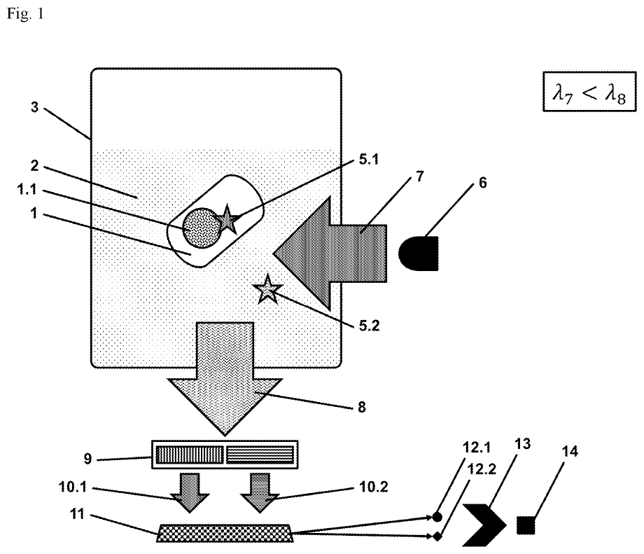

FIG. 1 shows a schematic representation of the method according to the invention. Cells 1 are cultivated in a reactor 3 filled with medium 2, the state of which is to be determined by means of the method according to the invention. This state determination is done via the interaction of at least one luminescent dye 5 with a cell structure 1.1, wherein this interaction leads to a change in the ambient conditions and therefore to a change in the luminescence anisotropy of the luminescent dye 5. This is represented in FIG. 1 as interacting luminescent dye 5.1 which has a high luminescence anisotropy as a result of the interaction with the cell structure 1.1 (parallel filling), and also as non-interacting luminescent dye 5.2 that has a lower luminescence anisotropy due to the lack of interaction (wavy filling).

As represented in FIG. 1, the method according to the invention is characterised in that light 7 polarised from at least one light source 6 is irradiated into the reactor 3 and the medium 2 where it excites molecules of the luminescent dye 5 to luminesce. The excited molecules of the luminescent dye 5 then emit light 8 which, depending on the proportions of the interacting luminescent dye 5.1 and of the free luminescent dye 5.2, has a certain anisotropy with regard to the intensity distribution in the various polarisation planes. In an advantageous embodiment of the invention, the wavelength of the polarised exciting light 7 is smaller than that of the emitted light 8. According to the invention, at least a part of the emitted light 8 leaves the medium 2 as well as the reactor 3 as represented in FIG. 1 as an advantageous embodiment of the invention, and is polarised by at least one polariser 9. The polarised emitted light 10 obtained in this way is detected by at least one light sensor 11 as a luminescence value 12. According to the invention, at least two luminescence values 12.1 and 12.2 are detected that differ with regard to the polarisation angles of the polarised emitted light 10.1 and 10.2. For this purpose, the polariser 9 according to the invention permits polarisation of light in at least two different polarisation angles (represented as a horizontal and vertical fill, respectively) and may be embodied, in particular, but not exclusively, both as a variable polariser 9 or as a dedicated arrangement of differently oriented individual polarisers 9. According to the invention, the at least two luminescence values 12.1 and 12.2 detected at different polarisation angles are calculated by means of appropriate mathematical methods 13 to form at least one anisotropy value 14 which, as a result of the interaction-dependent luminescence anisotropy of the at least one luminescent dye 5 correlates with at least one state of the cells 1 and therefore permits determination of this state of the cells 1.

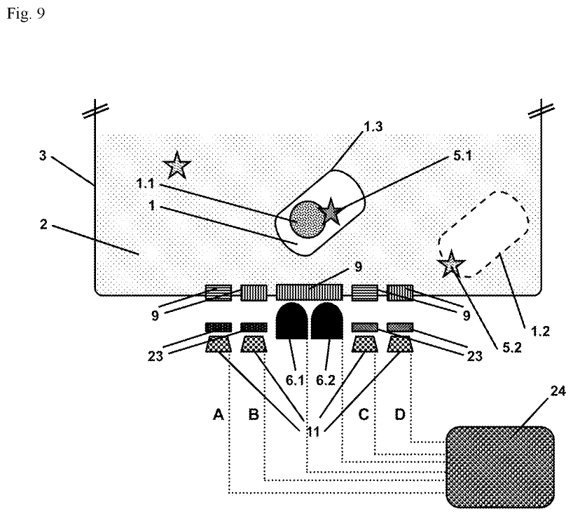

In an advantageous embodiment of the invention, such ratios between the wavelengths 2\, of the different light fractions as depicted in FIG. 1 are used. Depending on the embodiment, these are separated from each other as necessary by suitable wavelength-selective optical units 23, in particular, but not exclusively by optical filters, monochromators, prisms, gratings or by complete or partial spectral scans (see also FIGS. 8 and 9).

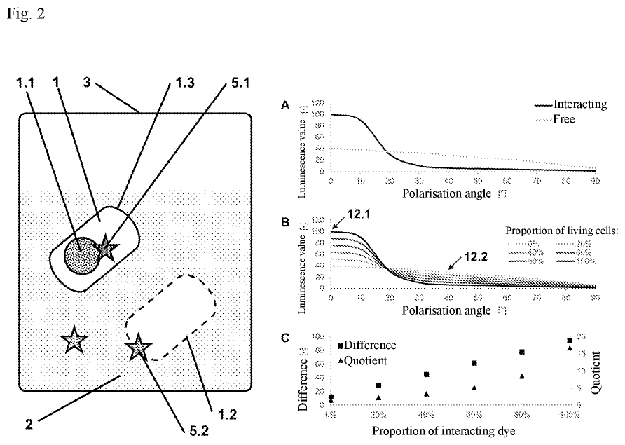

FIG. 2 shows a schematic representation of the interaction of a luminescent dye 5 according to the invention with a cell structure 1.1 in order to determine the state of cells 1. In doing so, FIG. 2 shows an example of a method for determining the proportion of living cells or the viability. Cells 1 are cultivated in a reactor 3 filled with medium 2. In a living state, the cells have at least one cell structure 1.1 (in particular, but not exclusively, proteins, e.g. enzymes with NADH or NADPH as co-factor/substrate/product) with which at least one luminescent dye 5 may interact (in particular, but not exclusively, by binding). FIG. 2 represents an example of an intrinsic luminescent dye 5 (e.g. NADH, NADPH) that is formed inside living cells 1 (top left) and cannot leave living cells 1 with an intact cell membrane on account of its charge. In doing so, the intact cell membrane also represents a cell structure 1.3 which can be involved in the determination of the state of the cells 1 according to the invention since it defines and limits the localisation of the luminescent dye 5. If the state of a cell 1 changes from living to dead (bottom right), the cell membrane (dashed border) disintegrates and becomes a cell structure 1.2 permeable for the luminescent dye 5. Furthermore, in the example embodiment of FIG. 2 for dead cells 1, there is no longer any interaction between the luminescent dye 5 and the cell structure 1.1, in particular, but not exclusively, because the luminescent dye 5 dissociates from the cell structure 1.1 and diffuses through the disintegrated cell membrane 1.2 into the medium 2 or because the cell structure 1.1 is no longer present or denatured in dead cells 1. Therefore, by using the method according to the invention, it is possible to determine the state of the cells 1.

In FIG. 2, the luminescent dye 5.1 interacting with the cell structure 1.1 shows a high luminescence anisotropy, whereas the free luminescent dye 5.2 has a lower luminescence anisotropy. This is represented in FIG. 2, diagram A, as luminescence value 12 as a function of the polarisation angle. In doing so, the interacting form of the luminescent dye 5.1 has high luminescence values 12 with low polarisation angles and significantly lower luminescence values 12 with greater polarisation angles. In contrast, the luminescence values 12 of the free luminescent dye 5.2 are much more uniformly distributed across the different polarisation angles.

If, according to the example represented in FIG. 2, there is a mixture of living and dead cells 1 in reactor 3, the interaction-dependent luminescence anisotropy of the luminescent dye 5 as a function of the proportion of living cells 1 results in the mixed luminescence values 12 represented in FIG. 2, diagram B, with the represented polarisation angles. Therefore, the detection of at least two luminescence values 12.1 and 12.2 at different polarisation angles according to the invention allows an evaluation of the luminescence anisotropy. In an advantageous embodiment of the invention, the luminescence values 12.1 and 12.2 are thereby preferably measured at such polarisation angles at which the difference in luminescence anisotropy of the interacting form of the luminescent dye 5.1 and the free form of the luminescent dye 5.2 is especially pronounced. Such a selection of the polarisation angles is highlighted by arrows in FIG. 2, diagram B, for the luminescence values 12.1 and 12.2. In particular, referring to FIG. 2, diagram A, the difference in luminescence anisotropies may be clearly seen, since at a polarisation angle of 0°, the luminescence value for the interacting luminescent dye 5.1 is substantially higher than that of the free luminescent dye 5.2. At a polarisation angle of 40°, these ratios are exactly reversed.

According to the invention, at least one anisotropy value 14 is now calculated from the at least two luminescence values 12.1 and 12.2 recorded at different polarisation angles by means of appropriate mathematical methods 13. This is represented as an example in FIG. 2, diagram C for the luminescence values 12.1 and 12.2 presented in FIG. 2, diagram B. Of the many suitable mathematical methods 13, FIG. 2, diagram C shows the subtraction of the luminescence value 12.2 from the luminescence value 12.1 and the division of the luminescence value 12.1 by the luminescence value 12.2. In this way the subtraction gives a difference as an anisotropy value 14 and the division gives a quotient as an anisotropy value 14. These are plotted in FIG. 2, diagram C against the proportion of interacting luminescent dye 5.1. Since this proportion correlates with the state of the cells 1 as a result of the cell state-dependent interaction, this clearly shows that the anisotropy values 14 determined according to the invention may be used to determine the state of cells 1.

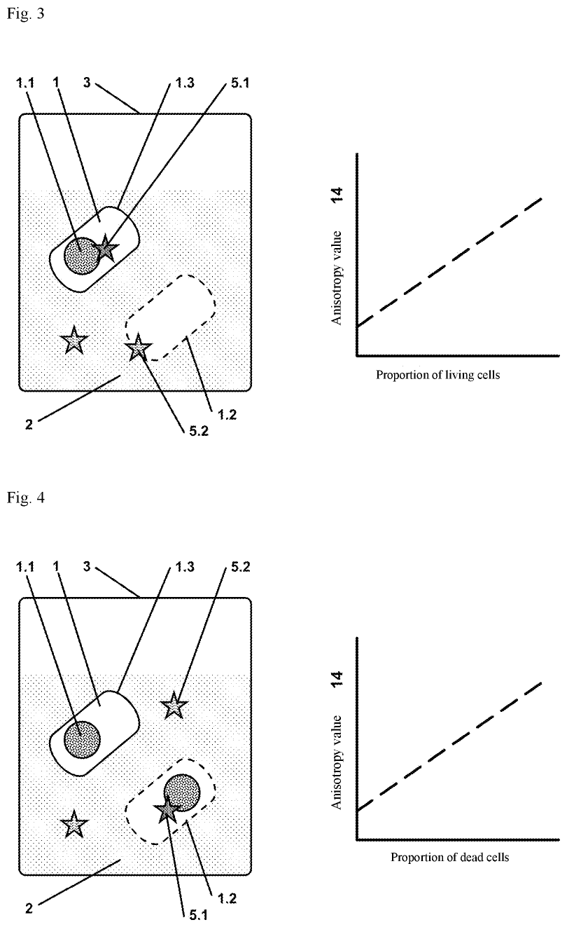

FIGS. 3 to 6 show schematic representations of the interaction of at least one luminescent dye 5 according to the invention for determining different states of cells 1. Cells 1 are cultivated in a reactor 3 in the medium 2 contained in it, for each of which, according to the invention, at least one state is to be determined via at least one anisotropy value 14 which correlates with the state to be determined via the interaction of at least one luminescent dye 5 with at least one cell structure 1.1 to 1.3. In the above-mentioned figures the interaction of at least one luminescent dye 5 according to the invention is represented schematically on the left in each case for this purpose, while the correlation between the state to be determined (on the X axis) and the at least one anisotropy value 14 detected according to the invention (on the Y axis) of at least one luminescent dye 5 is depicted on the right by way of example.

FIG. 3 shows a schematic representation of the interaction of a luminescent dye 5 according to the invention for determining the proportion of living cells 1. The luminescent dye 5 used shows an increased luminescence anisotropy when interacting with the cell structure 1.1. To determine the proportion of living cells 1, the luminescent dye 5 interacts with the cell structure 1.1 which is only present in living cells 1. In addition, the luminescent dye 5 accumulates in living cells 1 because they are surrounded by at least one intact cell membrane as cell structure 1.3. If the cells 1 die, the cell membrane becomes a permeable cell structure 1.2 so that the luminescent dye 5 diffuses out of dead cells 1 and is reduced there and, depending on the position of the interaction equilibrium, may possibly dissociate from the cell structure 1.1 that may still be present. This results in the correlation between the proportion of living cells 1 and the anisotropy value 14 which is represented on the right. The more living cells 1 enriched with luminescent dye 5 and interacting with it via cell structure 1.1 are present compared to non-interacting dead cells 1, the higher the anisotropy value 14. In this respect, the anisotropy value 14 will increase with the proportion of living cells 1 in the medium 2. In some embodiments of the invention, the anisotropy value 14 is converted into a percentage viability value. Examples of luminescent dyes accumulating in living cells 1 are NADH/NADPH or neutral red, wherein the former is formed by the living cell itself whereas the latter diffuses across the cell membrane from outside the cell in an uncharged state and then accumulates in acidic compartments as an “ion trap” in a charged state. Exemplary cell structures 1.1 for interaction with NADH or NADPH are enzymes. Exemplary cell structures 1.1 for interaction with neutral red are lysosomes, endosomes and their membranes or membrane components.

FIG. 4 shows a schematic representation of the interaction of a luminescent dye 5 according to the invention for determining the proportion of dead cells 1. The luminescent dye 5 used shows an increased luminescence anisotropy when interacting with the cell structure 1.1. However, in contrast to the embodiment represented in FIG. 3, the luminescent dye 5 is initially present only in the medium 2 and cannot, in particular, but not exclusively, due to its charge, pass across the cell membrane 1.2 into living cells 1 to interact with the cell structure 1.1 there. However, as dead cells 1 have a membrane 1.2 with holes which is thus permeable to the luminescent dye 5, it may enter the dead cells 1 and interact with the cell structure 1.1 there. This results in the correlation represented on the right, wherein with an increasing proportion of dead cells, the anisotropy value 14 increases. In some embodiments of the invention, the anisotropy value 14 is converted into a percentage viability value. Suitable luminescent dyes 5 for this embodiment are, for example, charged nucleic acid dyes such as propidium iodide with DNA or RNA as the cell structure 1.1 for interaction.

In some embodiments of the invention, the viability as a state of the cells 1 is determined by combining the determination of the proportion of living cells 1 (see FIG. 3) by means of a first luminescent dye 5 with the determination of the proportion of dead cells 1 (see FIG. 4) by means of a second luminescent dye 5. In an advantageous embodiment, the two luminescent dyes differ with regard to their excitation or emission wavelengths. Viability is then determined using suitable mathematical methods 13 from the anisotropy values 14 detected for each luminescent dye 5 used.

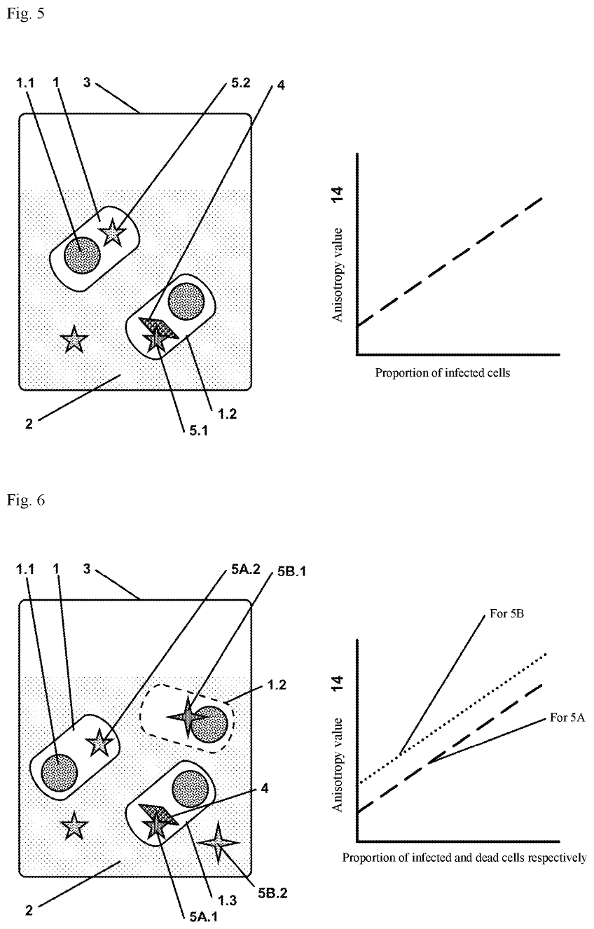

FIG. 5 shows a schematic representation of the interaction of a luminescent dye 5 according to the invention for determining the proportion of infected cells 1. In doing so, the luminescent dye 5 does not interact with a cell structure 1.1 but with a structure which is not actually part of the cell 1, in this case with a contaminant 4 that is here in the cell 1 and has infected it, for example mycoplasma or viruses. Interaction of the luminescent dye 5 with at least one component of the contaminant 4 will increase its luminescence anisotropy so that the luminescence value 14 detected according to the invention will increase with the proportion of infected cells 1. Suitable luminescent dyes 5 may be added externally, be present in the medium 2 or be formed by the cells 1 themselves. Therefore, in some embodiments of the invention, all cells 1 constitutively form an antibody fragment against a specific contaminant (e.g., mycoplasma or a virus). This antibody fragment is fused or conjugated with a luminescent dye 5, or a luminescent dye 5 binding structure, so that intracellular infections or contaminations 4 can be discovered.

FIG. 6 shows a schematic representation of the interaction of several luminescent dyes 5A/5B according to the invention for determining the proportion of infected and dead cells 1. In particular, the combination of different luminescent dyes for simultaneous or parallel determination of different states of cells 1 is represented. The embodiment depicted in FIG. 6 combines an embodiment for determining the proportion of dead cells 1 from FIG. 4 via the luminescent dye 5B with an embodiment for determining the proportion of infected cells 1 from FIG. 5 via the luminescent dye 5A. According to the invention, several different states of cells 1 can be detected in this way in parallel by combining suitable luminescent dyes 5. In an advantageous embodiment of the invention, the luminescent dyes 5 used differ with regard to their excitation wavelength or with regard to their emission wavelength or with regard to both above-mentioned wavelengths.

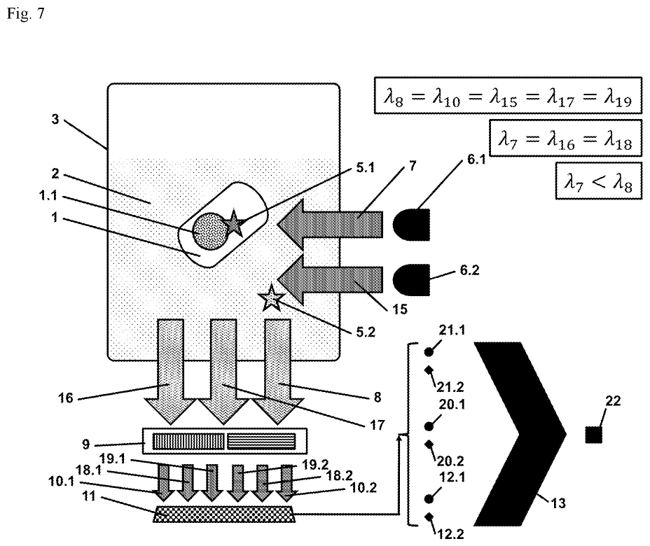

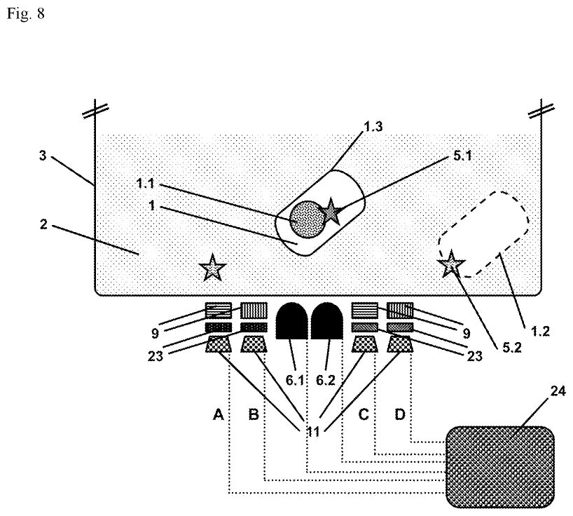

FIG. 7 shows a schematic representation of the method according to the invention with scattered light detection. Cells 1 are cultivated in a reactor 3 filled with medium 2, the state of which is to be determined by means of the method according to the invention. This state determination is done via the interaction of at least one luminescent dye 5 with a cell structure 1.1, wherein this interaction leads to a change in the ambient conditions and therefore to a change in the luminescence anisotropy of the luminescent dye 5. This is represented in FIG. 7 as interacting luminescent dye 5.1 which has a high luminescence anisotropy as a result of the interaction with cell structure 1.1 (parallel filling), and also as free luminescent dye 5.2 which has a lower luminescence anisotropy due to the lack of interaction (wavy filling). The embodiment of the method according to the invention represented in FIG. 7 extends the embodiment represented in FIG. 1 by a scattered light detection.

The method represented in FIG. 7 is characterised in that light 7 polarised from at least one light source 6.1 is irradiated into the reactor 3 and the medium 2 where it excites molecules of the luminescent dye 5 to luminescence. The excited molecules of the luminescent dye 5 then emit light 8 which, depending on the proportions of the interacting luminescent dye 5.1 and the free luminescent dye 5.2, has a certain anisotropy with regard to the intensity distribution in the various polarisation planes. In an advantageous embodiment of the invention, the wavelength of the polarised exciting light 7 is smaller than that of the emitted light 8. According to the invention, at least a part of the emitted light 8 leaves the medium 2 as well as the reactor 3 as represented in FIG. 7 as an advantageous embodiment of the invention, and is polarised by at least one polariser 9. The polarised emitted light 10 obtained in this way is detected as a luminescence value 12 by at least one light sensor 11. According to the invention, at least two luminescence values 12.1 and 12.2 are detected that differ with regard to the polarisation angles of the polarised emitted light 10.1 and 10.2. For this purpose, the polariser 9 according to the invention permits polarisation of light in at least two different polarisation angles (represented as a horizontal and vertical fill, respectively) and may be embodied, in particular, but not exclusively, both as a variable polariser 9 or as a dedicated arrangement of differently oriented individual polarisers 9.

The method represented in FIG. 7 is further characterised in that both the influence of light scattering (e.g. on cells or other particles or interfaces) of the exciting light 7 and the emitted light 8 are detected and included in the processing to a scatter-corrected anisotropy value 22. For this purpose, in addition to the emitted light 8, the scattered light 16 that at least partially leaves the medium 2 or the reactor 3 is also detected at excitation wavelength, wherein it is polarised by a polariser 9 at the same at least two polarisation angles of the polarised emitted light 10 and detected as polarised scattered light 18 (in at least two polarisation angles as 18.1/18.2) at excitation wavelength by at least one light sensor 11 as scattered light values 20 at excitation wavelength (in at least two polarisation angles as 20.1/20.2). For selective detection of the polarised scattered light 18 at excitation wavelength without interfering influences from ambient light or emitted light 8, suitable wavelength-selective optical units 23 can be used between the medium 2 and the light sensor 11 (e.g. grating in combination with CCD line sensor).

The method represented in FIG. 7 is further characterised in that the scattered light 17 leaving the medium 2 or the reactor 3 at least partially is also detected at emission wavelength. In order to quantify the pure scattering effect, polarised light 15 for scattering correction at emission wavelength is irradiated into the medium 2 or the reactor 3 by at least one second light source 6.2, with the light source 6.1 deactivated, and therefore with no luminescence of the luminescent dye 5, where it is scattered by cells or other particles or interfaces and leaves the medium 2 or the reactor 3 again at least partially as scattered light at emission wavelength 17. The scattered light 17 at emission wavelength is polarised by at least one polariser 9 in the same at least two polarisation angles as the polarised emitted light 10 and detected as polarised scattered light 19 (in at least two polarisation angles as 19.1/19.2) at emission wavelength by at least one light sensor 11 as scattered light values 21 at emission wavelength (in at least two polarisation angles as 21.1/21.2). For selective detection of the polarised scattered light 19 at emission wavelength without interfering influences of ambient light, appropriate wavelength-selective optical units 23 may be used between the medium 2 and the light sensor 11 (e.g. grating in combination with CCD line sensor).

The method represented in FIG. 7 is further characterised in that at least one scatter-corrected anisotropy value 22 is calculated from the at least two detected luminescence values 12.1/12. 2, the at least two detected scattered light values at excitation wavelength 20.1/20.2 as well as the at least two scattered light values at emission wavelength 21.1/21.2, which have all been detected at the same different at least two polarisation angles by means of suitable mathematical methods 13.

In an advantageous embodiment of the invention, such ratios between the wavelengths 2\, of the different light fractions as depicted in FIG. 7 are used. Depending on the embodiment, these are separated from each other as necessary by suitable wavelength-selective optical units 23, in particular, but not exclusively by optical filters, monochromators, prisms, gratings or by complete or partial spectral scans (see also FIGS. 8 and 9).

FIG. 8 shows a schematic representation of a device according to the invention with several light sources 6 and light sensors 11 for carrying out the method according to the invention. The device comprises a reactor 3 in which cells 1 are cultivated in a medium 2. The device comprises two light sources 6, wherein the wavelength ranges of the light source 6.1 and the light source 6.2 differ so that either several luminescent dyes 5 can be evaluated in parallel (see also FIG. 6) or a stray light correction can take place (see also FIG. 7).

The embodiment represented in FIG. 8 further comprises four light sensors 11, wherein each individual light sensor 11 is equipped with its own polariser 9 and a wavelength-selective optical unit 23 and is grouped together as a detector set as A, B, C or D. In doing so, the selected wavelengths of the wavelength-selective optical units 23 are similar in the detector sets A/B and C/D, respectively, whereas the polarisation angles of the polarisers 9 differ between the detector sets A/B and C/D, respectively. By using several light sensors 11 with associated wavelength-selective optical units 23 and polariser 9, the detection of luminescence values 12 or scattered light values 20/21 according to the invention and thus the determination of anisotropy values 14 can be parallelised advantageously.

The embodiment represented in FIG. 8 further comprises a computer 24 which is connected to the light sensors 11 in order to control them and to obtain data from them, in particular luminescence values 12 or scattered light values 20/21. The computer 24 is further connected to the light sources 6 to control them or to obtain data from them. The determination of anisotropy values 14 from luminescence values 12 or scattered light values 20/21 according to the invention is carried out using suitable mathematical methods 13 on the computer 24.

In an advantageous embodiment of the invention, the optical components 9/23, the light sources 6 and light sensors 11 of the embodiment represented in FIG. 8 are located outside the reactor 3, although in other embodiments they may also be located inside the reactor 3 or immersed in the medium 2 as immersion probes.

FIG. 9 shows a schematic representation of a device according to the invention with several light sources 6 and light sensors 11 and with polarisers 9 which are in contact with the medium 2. The embodiment is essentially similar to the one represented in FIG. 8. The only difference is the location of the polarisers 9, which are in contact with the medium 2 in FIG. 9 in order to minimise or eliminate the scattering of light by optical elements, interfaces or other device components. In this way, in this embodiment of the invention, only scattering effects within the medium 2 influence the determination of anisotropy values 14.

FIG. 9 represents a common polariser 9 for the two light sources 6.1/6.2, although in other embodiments this may already be part of the light sources 6, or it may otherwise be assigned to each individual light source 6.

The contact of the polarisers 9 with the medium 2 represented in FIG. 9 may be achieved in particular, but not exclusively, by immersion probes as well as by integration of the polarisers 9 into the outer wall of the reactor 3, e.g. as polarisation filter foil in disposable plastic reactors.

### LIST OF REFERENCE NUMERALS

The description and claims are to be observed for the respective interpretation of the reference numerals.
1 Cell (1.1, 1.2, 1.3—cell structures)
2 Medium
3 Reactor
4 Contamination
5 Luminescent dye (5.1, 5.2—under different environmental conditions or interaction states, 5A.1, 5A.2, 5B.1, 5B.2—different dyes under different environmental conditions or interaction states)
6 Light source (6.1, 6.2—with different wavelengths)
7 Polarised exciting light
8 Emitted light
9 Polariser
10 Polarised emitted light (10.1, 10.2—different polarisation angles)
11 Light sensor
12 Luminescence values (12.1, 12.2—different polarisation angles)
13 Mathematical methods
14. Anisotropy value
15 Polarised light for scattering correction at emission wavelength
16 Scattered light at excitation wavelength
17 Scattered light at emission wavelength
18 Polarised scattered light at excitation wavelength (18.1, 18.2—different polarisation angles)
19 Polarised scattered light at emission wavelength (19.1, 19.2—different polarisation angles)
20 Scattered light values at excitation wavelength (20.1, 20.2—different polarisation angles)
21 Scattered light values at emission wavelength (21.1, 21.2—different polarisation angles)
22 Scatter-corrected anisotropy value
23 Wavelength selective optical units
24 Computer

1. A method for evaluating viability and/or degree of contamination of cells, wherein the cells are cultivated in a medium located in a reactor, the method comprising
providing at least one luminescent dye in the reactor whose luminescence anisotropy is influenced by the viability or the degree of contamination of the cells,
exciting the at least one luminescent dye to luminesce by irradiating polarized light into the medium that is polarized by at least one light source,
polarizing light emitted by at least one luminescent dye that leaves the medium using at least one polarizer, and
detecting the polarized emitted light with at least one light sensor, wherein the polarized emitted light is detected as at least two luminescence values in at least two different polarization angles, and
determining at least one anisotropy value from the at least two luminescence values by means of mathematical methods, which correlates with the viability or the degree of contamination of the cells.

2. The method according to claim 1, characterised characterized in that the emitted polarized light is separated from the exciting light or ambient light by at least one wavelength-selective optical unit and is detected by at least one light sensor for the detection of at least one luminescence value.

3. The method according to claim 1, characterized in that several luminescent dyes are used for the determination of several states.

4. The method according to claim 1, characterized in that at least one luminescent dye used is formed by the cells themselves.

5. The method according to claim 1, characterized in that scattered light values are also detected at the same polarisation angles as the luminescence values and are calculated with the luminescence values by means of mathematical methods to form the at least one scatter-corrected anisotropy value.

6. The method according to claim 1, characterized in that temperature of the medium is also detected in order to be able to compensate for temperature dependencies of the luminescence anisotropy of at least one luminescent dye used.

7. A device set up to carry out the method according to claim 1, wherein the device comprises:
the at least one light source for irradiating polarized light into the medium that excites the at least one luminescent dye, and
the at least one light sensor which detects the polarized emitted light, and
the at least one polarizer, which is designed such that the emitted light can be polarized in at least two polarisation directions so that the at least one light sensor can detect the polarized emitted light in the at least two polarization angles.

8. The device according to claim 7, characterized in that the at least one light source or the at least one light sensor are each equipped with at least one wavelength-selective optical unit so that the at least one light sensor cannot detect light from the at least one light source.

9. The device according to claim 7, characterized in that one respective light sensor is equipped with its own polarizer and a wavelength-selective optical unit as a detector set, and the device comprises at least one detector set for each luminescence value and polarisation angle to be detected.

10. The device according to claim 7, characterized in that at least one polarizer is arranged such that it is in contact with the medium.
